(19) United States
(12) Patent Application Publication
(10) Pub. No.: US 2007/0220881 A1
(43) Pub. Date: Sep. 27, 2007

(54) External combustion engine

(75) Inventors: Katsuya Komaki, Kariya-city (JP); Shinichi Yatsuzuka, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/726,296

(22) Filed: Mar. 21, 2007

(30) Foreign Application Priority Data
Mar. 22, 2006 (JP) 2006-078803

(51) Int. Cl. F02G 1/04; F01K 3/00; F01B 29/10; F01K 1/00

(52) U.S. Cl. 60/517; 60/659

(57) ABSTRACT

An external combustion engine comprising a container (11) sealed with a working liquid (12) in a way adapted to allow the liquid to flow therein, a heating unit (13, 30) for heating and vaporizing the working liquid (12) in the container (11), and a cooling unit (14) for cooling and liquefying the vapor of the working liquid (12) heated and vaporized by the heating unit (13, 30) is disclosed, wherein the displacement of the working liquid (12) caused by the volume change of the vapor is output by being converted into mechanical energy. A pressure regulating unit (16, 60, 63) regulates the internal pressure (Pc) of the container (11). A control unit (21) controls the pressure regulating unit (16, 60, 63) based on at least the temperature (T1) of the heated portion (11a) of the container (11) for vaporizing the working liquid (12). The control unit (21) calculates the temperature (T1) based on at least the heat quantity (Q) applied from the heating unit (13 30) to the working liquid (12).

### BACKGROUND OF THE INVENTION

1. Field of the Invention

This invention relates to an external combustion engine for outputting mechanical energy by converting the displacement of a working liquid, caused by the volume change of the vapor of the working liquid, into mechanical energy.

2. Description of the Related Art

In the prior art, an external combustion engine, in which a working liquid is sealed in a container, is disclosed in Japanese Unexamined Patent Publication No. 2005-330910. Part of the working liquid in the container is heated and vaporized by a heater and the vapor of the working liquid thus vaporized is cooled and liquefied by a cooler thereby to output energy by converting the displacement of the working liquid, caused by the volume change of the vapor of the working liquid, into mechanical energy.

This prior art comprises a pressure sensor for detecting the internal pressure of the container, a temperature sensor for detecting the temperature of the heated portion of the container for vaporizing the working liquid, a valve for discharging the working liquid in the container into the atmosphere and a control unit for controlling the on/off operation of the valve.

By reducing the volume of the working liquid by discharging part thereof in the container into the atmosphere when the internal pressure of the container increases to not lower than the saturated vapor pressure of the working liquid at the temperature of the heated portion, the internal pressure of the container is controlled not to exceed the saturated vapor pressure of the working liquid.

As a result, the condensation and liquefaction of part of the vapor with the internal pressure of the container exceeding the saturated vapor pressure of the working liquid is suppressed to thereby suppress the output and efficiency reduction of the external combustion engine.

### SUMMARY OF THE INVENTION

In this conventional technique, however, the temperature of the heated portion is detected directly by a temperature sensor, and therefore, the temperature sensor is required to be arranged in contact with the heated portion. As a result, the problem is posed that the temperature sensor is liable to be damaged by the high temperature of the heated portion.

In view of this point, a first object of this invention is to suppress the reduction in output and efficiency of the external combustion engine without detecting the temperature of the heated portion directly.

In view of the point described above, a second object of the invention is to estimate the temperature of the heated portion without detecting the temperature thereof directly.

This invention has been conceived to achieve the objects described above and provides an external combustion engine for outputting mechanical energy by converting the displacement of a working liquid (12) caused by the volume change of the vapor into mechanical energy, comprising:

a container (11) sealed with the working liquid (12) in a way adapted to allow the liquid to flow therein;

a heating means (13, 30) for heating and vaporizing the working liquid (12) in the container (11);

a cooling means (14) for cooling and liquefying the vapor of the working liquid (12) heated and vaporized by the heating means (13, 30);

a pressure regulating means (16, 60, 63) for regulating the internal pressure (Pc) of the container (11); and

a control means (21) for controlling the pressure regulating means (16, 60, 63) based on at least the temperature (T1) of the heated portion (11a) of the container (11) for vaporizing the working liquid (12);

wherein the control means (21) calculates the temperature (T1) based on at least the heat quantity (Q) applied to the working liquid (12) from the heating means (13, 30).

In this configuration, the temperature (T1) of the heated portion (11a) is calculated by the control means (21) based on at least the heat quantity (Q) applied to the working liquid (12) from the heating means (13, 30), and therefore, the temperature (T1) of the heated portion (11a) can be estimated without detecting the temperature (T1) of the heated portion (11a) directly.

Based on the temperature (T1) of the heated portion (21) thus estimated, the pressure regulating means (16, 60, 63) is controlled, and therefore, the reduction in output and efficiency of the external combustion engine (10) can be suppressed. As a result, the reduction in output and efficiency of the external combustion engine (10) can be suppressed without detecting the temperature (T1) of the heated portion (11a) directly.

According to this invention, specifically, the control means (21) calculates the saturated vapor pressure (Ps1) of the working liquid (12) at the temperature (T1) based on the temperature (T1) and the vapor pressure curve of the working liquid (12).

According to this invention, more specifically, the control means (21) controls the pressure regulating means (63) in such a manner as to reduce the internal pressure (Pc), if not lower than the saturated vapor pressure (Ps1).

Also, according to this invention, more specifically, the control means (21) may control the pressure regulating means (16, 60) in such a manner that the internal pressure (Pc) is decreased if not lower than the saturated vapor pressure (Ps1) and increased if not higher than the saturated vapor pressure (Ps1).

Also, according to this invention, more specifically, the control means (21) may control the pressure regulating means (16) in such a manner that the internal pressure (Pc) is decreased in the case where the average value (Pca) of the internal pressure (Pc) is not lower than a target value (Pc0) calculated based on at least the saturated vapor pressure (Ps1) and the internal pressure (Pc) is increased in the case where the average value (Pca) is not higher than the target value (Pc0).

Also, according to this invention, there is provided a temperature calculating device used with an external combustion engine for outputting mechanical energy by converting the displacement of the working liquid (12) caused by the vapor volume change into mechanical energy, comprising a container (11) sealed with the working liquid (12) adapted to allow the liquid to flow therein, a heating means (13, 30) for heating and vaporizing the working liquid (12) in the container (11) and a cooling means (14) for cooling and liquefying the vapor of the working liquid (12) heated and vaporized by the heating means (13, 30),

wherein the temperature (T1) of the heated portion (11a) of the container (11) for vaporizing the working liquid (12) is calculated based on at least the heat quantity (Q) applied to the working liquid (12) from the heating means (13, 30).

As a result, the temperature of the heated portion can be estimated without detecting the temperature of the heated portion directly.

According to this invention, specifically, the control means (21) can calculate the temperature (T1) using Equation (1) below:

T1=Q/(m·Cp)−T0 (1)

where m is the mass of the heated portion (11a), Cp the specific heat of the heated portion (11a), and T0 the temperature of the heated portion (11a) before being heated by the heating means (13, 30).

Also, according to this invention, specifically, the heating means is an electric heater (13), the external combustion engine further comprising a wattage detecting means (22) for detecting the wattage (Q1) input to the electric heater (13), and

the control means (21) can calculate the temperature (T1) using the wattage (Q1) in place of the heat quantity (Q).

Also, according to this invention, specifically, the heating means is a heater (30) for exchanging heat with a high-temperature gas, the external combustion engine comprising:

a first temperature detecting means (34) for detecting the temperature (Tgi) of the high-temperature gas before exchanging heat with the heated portion (11a);

a second temperature detecting means (35) for detecting the temperature (Tgo) of the high-temperature gas after exchanging heat with the heated portion (11a); and

a flow rate detecting means (33) for detecting the flow rate (mg) of the high-temperature gas;

wherein the control means (21) may calculate the heat quantity (Q) based on at least the temperature (Tgi) of the high-temperature gas before exchanging heat with the heated portion (11a), the temperature (Tgo) of the high-temperature gas after exchanging heat with the heated portion (11a) and the flow rate (mg).

According to this invention, more specifically, the control means (21) can calculate the heat quantity (Q) using Equation (2) below.

Q=mg·Cgp·(Tgi−Tgo) (Equation (2))

where Cgp is the specific heat of the high-temperature gas.

Incidentally, the reference numerals inserted in the parentheses following the name of each means described in this column and the claims indicate the correspondence with the specific means described in the embodiments explained later.

The present invention may be more fully understood from the description of preferred embodiments of the invention, as set forth below, together with the accompanying drawings.

### BRIEF DESCRIPTION OF THE DRAWINGS

FIG. 1 is a diagram showing a general configuration of a power generating device according to a first embodiment of the invention.

FIG. 2 is a diagram for explaining the operation characteristics of an external combustion engine according to the first embodiment of the invention.

FIG. 3A is a PV diagram for the external combustion engine according to the first embodiment, showing an ideal state.

FIG. 3B is a PV diagram for the external combustion engine according to the first embodiment, showing a state in which the peak value of the internal pressure of the container is lower than the saturated vapor pressure.

FIG. 3C is a PV diagram for the external combustion engine according to the first embodiment, showing a state in which the peak value of the internal pressure of the container is higher than the saturated vapor pressure.

FIG. 4A is a diagram for explaining the problem posed by the conventional steam engine, showing a state in which the volume of the working liquid 12 is reduced.

FIG. 4B is a diagram for explaining the problem posed by the conventional steam engine, showing a state in which the volume of the working liquid 12 is increased.

FIG. 5 is a graph showing the relation between the volume of the working liquid and the efficiency of the external combustion engine.

FIG. 6 is a block diagram showing a general control operation according to the first embodiment.

FIG. 7 is a graph showing the vapor pressure curve of the working liquid.

FIG. 8 is a diagram showing a general configuration of the power generating device according to a second embodiment of the invention.

FIG. 9 is a diagram showing a general configuration of the power generating device according to a third embodiment of the invention.

FIG. 10 is a block diagram showing a general control operation according to the third embodiment.

FIG. 11 is a diagram showing a general configuration of the power generating device according to a fourth embodiment of the invention.

FIG. 12 is a block diagram showing a general control operation according to the fourth embodiment.

FIG. 13 is a diagram showing a general configuration of the power generating device according to a fifth embodiment of the invention.

FIG. 14 is a block diagram showing a general control operation according to the fifth embodiment.

FIG. 15 is a diagram showing a general configuration of the power generating device according to a sixth embodiment of the invention.

FIG. 16 is a graph showing the temperature gradient of a regulating container according to the sixth embodiment of the invention.

FIG. 17 is a block diagram showing a general control operation according to the sixth embodiment.

FIG. 18 is a diagram showing a general configuration of the power generating device according to a seventh embodiment of the invention.

FIG. 19 is a block diagram showing a general control operation according to the seventh embodiment.

FIG. 20 is a diagram showing a general configuration of the power generating device according to an eighth embodiment of the invention.

FIG. 21 is a block diagram showing a general control operation according to the eighth embodiment.

FIG. 22 is a diagram showing a general configuration of the power generating device according to a ninth embodiment of the invention.

FIG. 23 is a time chart for explaining the operation of a control unit according to the ninth embodiment of the invention.

### DESCRIPTION OF THE PREFERRED EMBODIMENTS

### First Embodiment

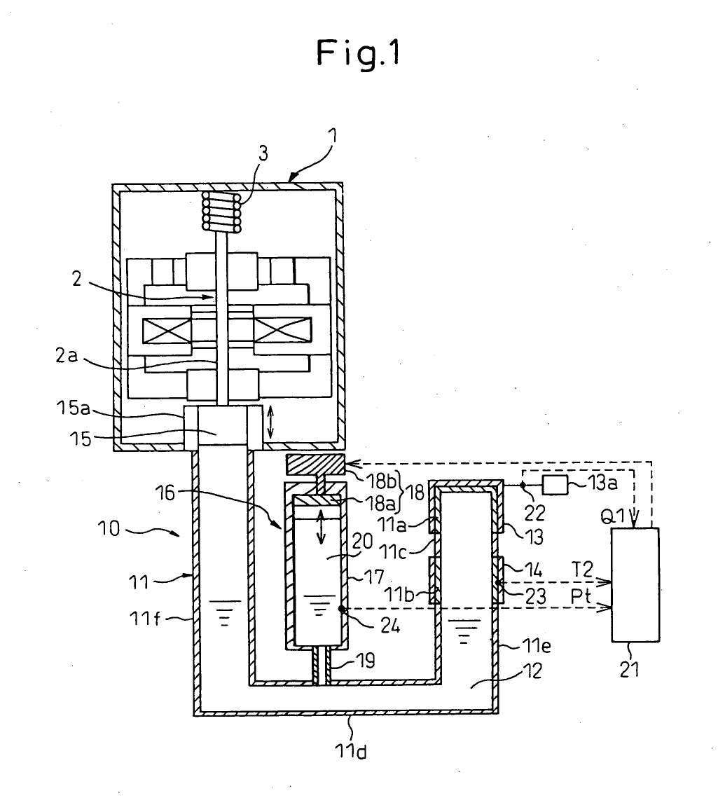

A first embodiment of the invention is explained below with reference to FIGS. 1 to 7. FIG. 1 is a diagram showing a general configuration of a power generating device including an external combustion engine 10 and a power generator 1 according to this invention.

As shown in FIG. 1, the external combustion engine 10 according to this invention, which is for driving a generator 1 to generate the electromotive force by vibrating and displacing a movable element 2 with a permanent magnet embedded therein, comprises a container 11 sealed with a working liquid (water in this embodiment) 12 adapted to allow the liquid to flow therein, an electric heater 13 making up a heating means for heating and vaporizing the working liquid 12 in the container 11, and a cooler 14 making up a cooling means for cooling the vapor of the working liquid 12 heated and vaporized by the electric heater 13.

The temperature of this electric heater 13 is regulated by a temperature controller 13a. Also, the cooling water is circulated in the cooler 14 according to this embodiment. Though not shown, a radiator for radiating the heat taken away from the vapor of the working liquid 12 by the cooling water is arranged in the cooling water circulating circuit.

According to this embodiment, the heated portion 11a making up a portion of the container 11 in contact with the electric heater 13 and the cooled portion 11b making up a portion of the container 11 in contact with the cooler 14 are formed of copper or aluminum high in heat conductivity.

An intermediate portion 11c of the container 11 between the heated portion 11a and the cooled portion 11b, on the other hand, is formed of stainless steel high in heat insulation property. Incidentally, the portion of the container 11 nearer to the generator 1 than the cooled portion 11b is also formed of stainless steel high in heat insulating property.

The container 11 is a pipe-like pressure vessel formed substantially in the shape of U having first and second linear portions 11e, 11f with a bent portion lid at the lowest position. The electric heater 13 and the cooler 14 are arranged, with the electric heater 13 above the cooler 14, in the first linear portion 11e at one horizontal end of the container 11 (right side on the page) with the bent portion 11d therebetween.

Though not shown, in order to secure the space to vaporize the working liquid 12, a gas of a predetermined volume is sealed at the upper end portion of the first linear portion 11e. This gas may be air, for example, or the pure vapor of the working liquid 12.

At the upper end of the second linear portion 11f of the container 11 at the other horizontal end (left side on the page) with the bent portion 11d therebetween, on the other hand, a piston 15 adapted to be displaced under the pressure from the working liquid is arranged slidably in a cylinder portion 15a.

The piston 15 is coupled to the shaft 2a of a movable element 2, and a spring 3 making up an elastic means for generating the elastic force to press the movable element 2 toward the piston 15 is arranged on the side of the movable element 2 far from the piston 15.

The bent portion 11d of the container 11 is connected with a pressure regulating means 16 for regulating the internal pressure (hereinafter referred to as the in-container pressure) Pc of the container 11. This pressure regulating means 16 is comprised of a pressure regulating container 17 and a piston mechanism 18. The pressure regulating container 17 communicates with the bent portion 11d through a connecting pipe 19. The pressure regulating container 17 is filled up with a pressure regulating liquid 20. According to this embodiment, the pressure regulating container 17 is arranged above the bent portion lid, and the pressure regulating liquid 20 is water as is the working liquid 12.

The pressure regulating container 17 and the connecting pipe 19 are desirably formed of a material high in heat insulating property. According to this embodiment, the pressure regulating liquid 20 being water, the pressure regulating container 17 and the connecting pipe 19 are formed of stainless steel.

The piston mechanism 18 is for regulating the internal pressure (hereinafter referred to as the regulating container internal pressure) Pt of the pressure regulating container 17, and comprised of a pressure regulating piston 18a and an electrically-operated actuator 18b.

The pressure regulating piston 18a is arranged at the upper end portion in the pressure regulating container 17 and adapted to be reciprocated vertically by the electrically-operated actuator 18 external to the pressure regulating container 17.

Next, an electronic control unit according to this embodiment is briefly explained. The control unit 21 includes a well-known microcomputer having a CPU, a ROM, a RAM, etc. and a peripheral circuit thereof and corresponds to the control means according to this invention.

The control unit 21, in order to control the pressure regulating means 16, is supplied with the detection signals from a wattage sensor 22 for detecting the wattage Q1 input to the electric heater 13, a cooled portion temperature sensor 23 for detecting the temperature (hereinafter referred to as the cooled portion temperature) T2 of the cooled portion 11b and an regulating container internal pressure sensor 24 for detecting the regulating container internal pressure Pt. Incidentally, the wattage sensor 22 corresponds to the wattage detecting means according to the invention.

The control unit 21 controls the drive of the electrically-operated actuator 18b based on the detection signals from the sensors 22 to 24.

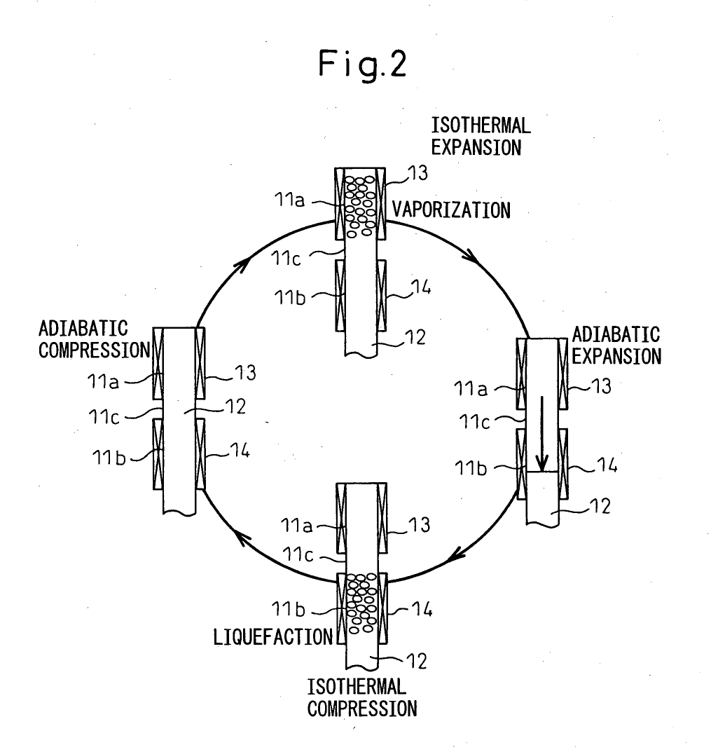

Next, the operation with this configuration is explained with reference to FIG. 2. With the activation of the electric heater 13 and the cooler 14, the working liquid (water) 12 in the heated portion 11a is heated and vaporized by the electric heater 13, and the high-temperature high-pressure vapor of the working liquid 12 is accumulated in the heated portion 11a thereby to push down the liquid level of the working liquid 12 in the first linear portion 11e. Then, the working liquid 12 sealed in the container 11 is displaced from the first linear portion 11e toward the second linear portion 11f and pushes up the piston 15 on the generator 1 side.

In the case where the liquid level of the working liquid 12 in the first linear portion 11e of the container 11 falls to the cooled portion 11b and the vapor of the working liquid 12 advances into the cooled portion 11b, then the vapor of the working liquid 12 is cooled and liquefied by the cooler 14. Thus, the force to push down the liquid level of the working liquid 12 in the first linear portion 11e is extinguished and the liquid level in the first linear portion 11e rises. As a result, the vapor of the working liquid 12 is expanded, and the piston 15 on the generator 1 side which has been pushed up moves down.

This operation is repeatedly executed until the electric heater 13 and the cooler 14 are deactivated. In the meantime, the working liquid 12 in the container 11 is periodically displaced (by what is called the self vibration) thereby to move the movable element 2 of the generator 1 vertically.

The present inventor has acquired, through experiment and analysis, the following knowledge about the relation between the peak value Pc of the in-container pressure Pc and the performance (output and efficiency) of the external combustion engine 10.

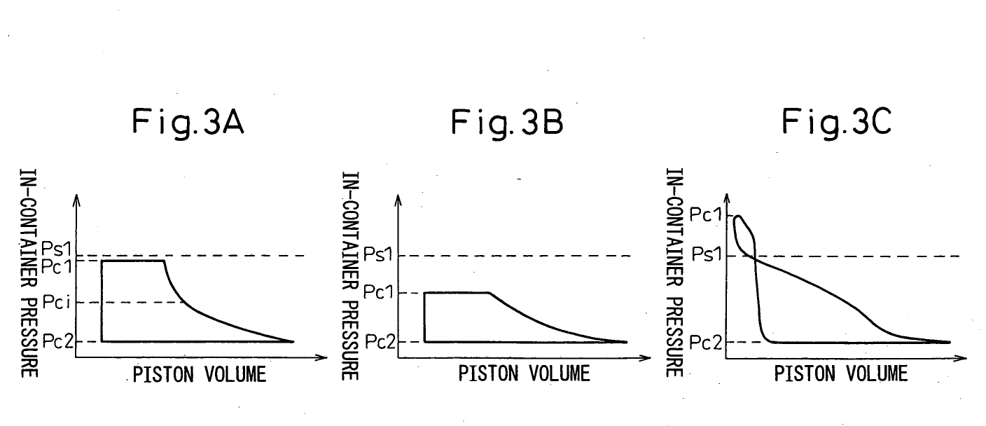

FIG. 3A shows the PV diagram in a given state of the external combustion engine 10. The abscissa of this PV diagram represents the volume (hereinafter referred to as the piston volume) of the space defined by the container 11 and the piston 15, and the piston volume changes with the reciprocal motion of the piston 15. This is also the case with the abscissa of the PV diagram shown in FIGS. 3B, 3C.

FIG. 3A shows a PV diagram showing a state in which the peak value Pc1 of the in-container pressure Pc is lower than the saturated vapor pressure Ps1 of the working liquid 12 at the temperature (hereinafter referred to as the heated portion temperature) T1 of the heated portion 11a and nearest to the saturated vapor pressure Ps1. In the process, an ideal state prevails in which the work done per period of the external combustion engine 10 is largest and the performance (output and efficiency) of the external combustion engine 10 is highest.

FIG. 3B, on the other hand, is a PV diagram with the peak value Pc1 extremely lower than the saturated vapor pressure Ps1. Under this condition, the work done per period is so small that the performance (output and efficiency) of the external combustion engine 10 is reduced.

FIG. 3C shows a PV diagram with the peak value Pc1 higher than the saturated vapor pressure Ps1. Specifically, with the increase in the heated portion temperature T1, the high-temperature vapor exists in the heater 12 even in the case where the piston volume is largest with the piston 15 located at the bottom dead center (the highest position in FIG. 1).

In the process, the piston 15 moves from the bottom dead center toward the top dead center (lowest position in FIG. 1). With the reduction in the piston-controlled volume, the vapor of the working liquid 12 is compressed and the in-container temperature P rises. Also, the working liquid 12, advancing into the heated portion 11a, is heated and vaporized, and therefore, the in-container pressure Pc further increases. As a result, the peak value Pc1 exceeds the saturated vapor pressure Ps1.

As long as the peak value Pc1 is higher than the saturated vapor pressure Ps1 as described above, the peak value Pc1 exceeds the saturated vapor pressure Ps1. Therefore, part of the vapor of the working liquid 12 is condensed and liquefied. As a result, the negative work for moving the piston 15 downwardly is done, thereby reducing the performance (output and efficiency) of the external combustion engine 10.

In order to achieve the highest performance (output and efficiency) of the external combustion engine 10, therefore, a state should be maintained in which the peak value Pc1 of the in-container pressure Pc is kept lower than the saturated vapor pressure Ps1 of the working liquid 12 at the heated portion temperature T1 and as near to the saturated vapor pressure Ps1 as possible.

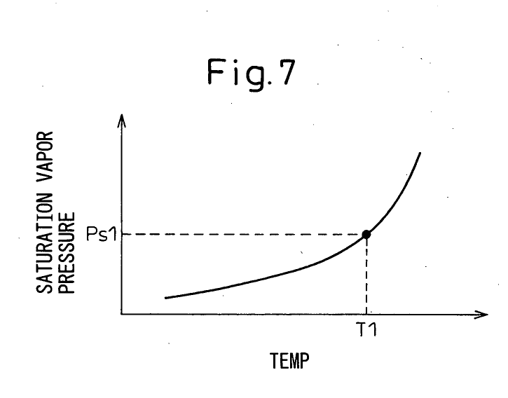

As is well known, however, the saturated vapor pressure Ps1 of the working liquid 12 changes with the heated portion temperature T1 (see FIG. 7 described later). Also, the peak value Pc1 of the in-container pressure Pc changes with the change in the heated portion temperature T1 and the temperature (hereinafter referred to as the cooled portion temperature) T2 of the cooled portion 11b and the leakage of the working liquid 12 from the container 11.

Specifically, in the case where the heated portion temperature T1 and the cooled portion temperature T2 decrease with the decrease in the temperature of the electric heater 13 and the temperature of the cooling water circulating in the cooler 14, accompanied by the temperature reduction of the working liquid 12, then the working liquid 12 is thermally compressed and the volume thereof is reduced. Also, the leakage of the working liquid 12 from the container 11, even in a small amount at a time, reduces the volume of the working liquid 12.

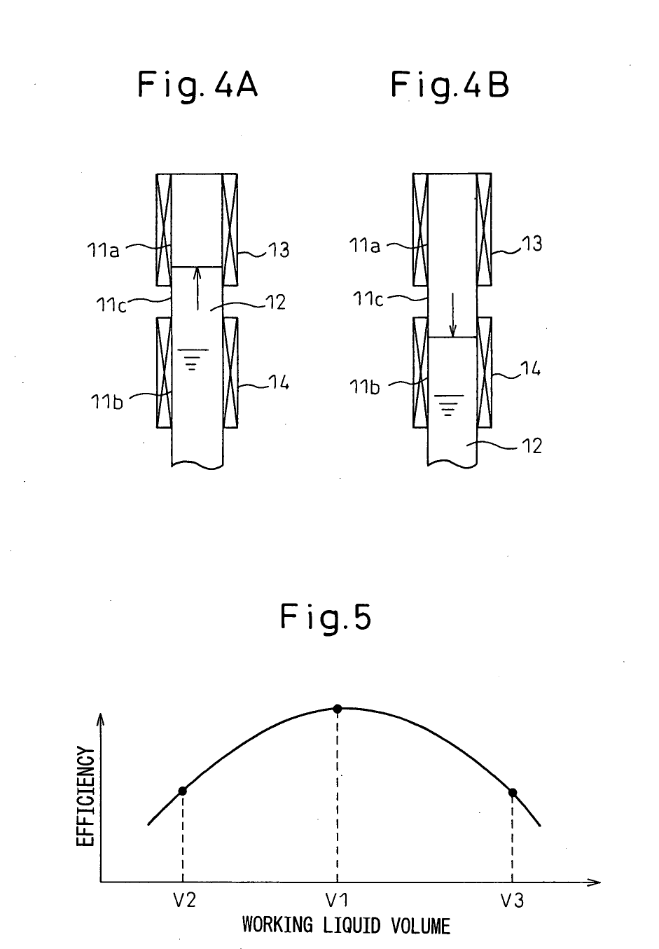

Once the volume of the working liquid 12 is reduced, as shown in FIG. 4A, the working liquid 12 fails to advance sufficiently into the heated portion 11a even in the case where the piston 15 is located at the top dead center (lowest position in FIG. 1) and the piston volume is minimum.

As a result, the vaporization of the working liquid 12 in the heated portion 11a is suppressed, thereby reducing the peak value Pc1 of the in-container pressure Pc.

In the case where the heated portion temperature T1 and the cooled portion temperature T2 increase and hence the volume of the working liquid 12 increases, on the other hand, as shown in FIG. 4B, the vapor fails to advance sufficiently into the cooled portion 11b even in the case where the piston 15 is located at the bottom dead center (highest position in FIG. 1) and the piston volume is maximum.

As a result, the liquefaction of the vapor in the cooled portion 11b is suppressed, thereby increasing the peak value Pc1 of the in-container pressure Pc.

FIG. 5 is a graph showing the relation between the volume of the working liquid 12 and the efficiency of the external combustion engine 10. Though not shown, the relation between the volume of the working liquid 12 and the output of the external combustion engine 10 is similar to the relation shown in FIG. 5.

As can be understood from FIG. 5, in the case where the volume of the working liquid 12 is a predetermined value V1, the performance (output and efficiency) of the external combustion engine 10 is highest. Under this condition, the PV diagram is plotted as shown in FIG. 3A.

In the case where the volume of the working liquid 12 assumes the value V2 smaller than a predetermined volume V1, on the other hand, the PV diagram is as shown in FIG. 3B, and the performance (output and efficiency) of the external combustion engine 10 is decreased. In the case where the volume of the working liquid 12 is V3 and larger than the predetermined volume V1, on the other hand, the PV diagram as shown in FIG. 3C is plotted, and the performance (output and efficiency) of the external combustion engine 10 is decreased.

In view of this, according to this embodiment, while the external combustion engine 10 is in operation, the in-container pressure Pc is regulated in such a manner that the peak value Pc1 of the in-container pressure Pc is lower than the saturated vapor pressure Ps1 of the working liquid 12 at the heated portion temperature T1 and as near to the saturated vapor pressure Ps1 as possible. In this way, the reduction in the performance (output and efficiency) of the external combustion engine 10 due to the change in the saturated vapor pressure Ps1 or the change in the peak value Pc1 of the in-container pressure Pc is suppressed.

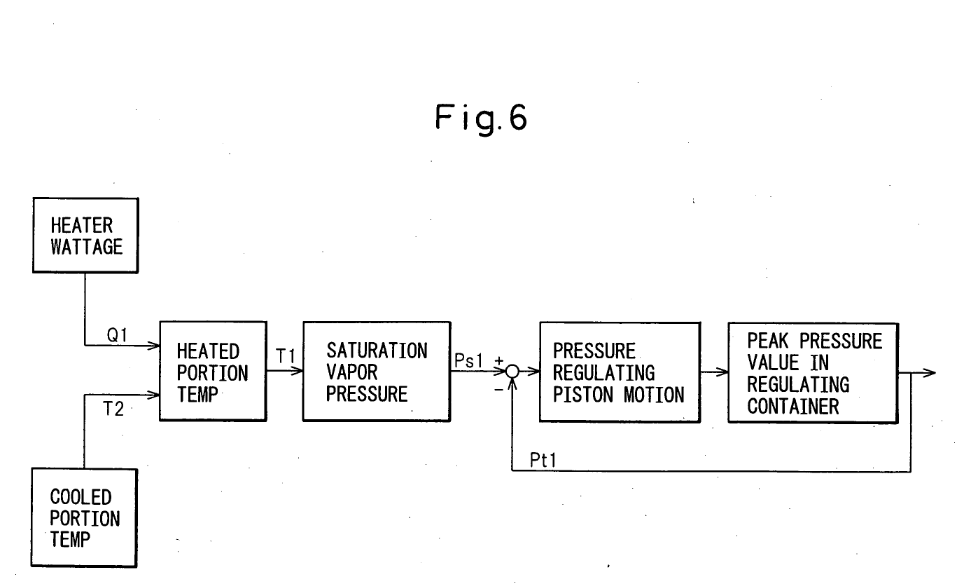

FIG. 6 is a block diagram showing a general control operation according to this embodiment. First, the heated portion temperature T1 is calculated according to Equation (1) below.

T1=Q/(m·Cp)−T0 (1)

where Q is the heat quantity (kJ) applied to the working liquid 12 from the heating means (electric heater 13 in this case), m the mass (kg) of the heated portion 11a, Cp the specific heat (kJ/kg·K) of the heated portion 11a and T0 the temperature (K) of the heated portion 11a before being heated by the heating means.

According to this embodiment, the heat quantity Q applied from the electric heater 13 to the working liquid 12 is substantially equal to the wattage Q1 input to the electric heater 13, and the temperature T0 of the heated portion 11a before being heated is substantially equal to the cooled portion temperature T2.

According to this embodiment, therefore, the heated portion temperature T1 is calculated from Equation (1) using the wattage Q1 input to the electric heater 13 in place of the heat quantity Q applied from the electric heater 13 to the working liquid 12 and the cooled portion temperature T2 in place of the temperature T0 of the heated portion 11a before being heated.

Incidentally, in place of the temperature T0 of the heated portion 11a before being heated, the cooled portion temperature T2 is not necessarily used, but the temperature of the portion of the container 11 other than the heated portion 11a and the cooled portion 11b, the ambient temperature in the neighborhood of the heated portion 11a or other temperature approximate to the temperature T0 of the heated portion 11a before being heated, may be used in place of the temperature T0 of the heated portion 11a before being heated.

Next, based on the heated portion temperature T1 calculated by Equation (1) and the vapor pressure curve of the working liquid 12 shown in FIG. 7, the saturated vapor pressure Ps1 of the working liquid 12 at the heated portion temperature T1 is calculated.

In the case where the peak value Pt1 of the regulating container internal pressure Pt is lower than the saturated vapor pressure Ps1, the electrically-operated actuator 18b pushes out the pressure regulating piston 18a thereby to reduce the volume of the pressure regulating container 17. As a result, the pressure regulating liquid 20 is compressed and the regulating container internal pressure Pt rises, while at the same time increasing the peak value Pt1 of the regulating container internal pressure Pt.

In the case where the peak value Pt1 of the regulating container internal pressure Pt is higher than the saturated vapor pressure Ps1, on the other hand, the electrically-operated actuator 18b pulls in the pressure regulating piston 18a and increases the volume of the pressure regulating container 17. As a result, the pressure regulating liquid 20 is expanded and the regulating container internal pressure Pt decreases, thereby decreasing the peak value Pt1.

The container 11 communicates with the pressure regulating container 17 through the connecting pipe 19, and therefore the in-container pressure Pc follows the regulating container internal pressure Pt. As a result, the peak value Pc1 of the in-container pressure Pc can be rendered to approach the saturated vapor pressure Ps1 of the working liquid 12 at the heated portion temperature T1.

Therefore, the operating condition of the external combustion engine 10 can always be rendered to approach the ideal state. Thus, the reduction in the performance (output and efficiency) of the external combustion engine 10 which otherwise would occur due to the change in the saturated vapor pressure Ps1 or the change in the peak value Pc1 of the in-container pressure Pc can be suppressed.

According to this embodiment, the heated portion temperature T1 is calculated from the wattage Q1, etc. input to the electric heater 13. As a result, the heated portion temperature T1 can be estimated without detecting it directly, and therefore, the performance reduction of the external combustion engine 10 can be suppressed without detecting the heated portion temperature T1 directly.

The sensors 22 to 24 used in this embodiment can be arranged at other than the heated portion 11a. Thus, the trouble such as the damage to the sensors 22 to 24 which otherwise might be caused by the high temperature of the heated portion 11a can be avoided.

According to this embodiment, the pressure regulating liquid 20 in the pressure regulating container 17 is identical with the working liquid 12. Nevertheless, a liquid such as a liquid metal, higher in compressibility than the working liquid 12, may be used as the pressure regulating liquid 20. As a result, the displacement amount of the pressure regulating piston 18a can be reduced as compared with a case in which the pressure regulating liquid 20 is identical with the working liquid 12, thereby making it possible to reduce the size of the external combustion engine 10.

Incidentally, in the case where a liquid metal is used as the pressure regulating liquid 20, it is recommended that, as the specific gravity of the liquid metal is larger than that of the working liquid 12, the pressure regulating container 17 should be arranged under the bent portion 11d to prevent,the pressure regulating liquid 20 from mixing with the working liquid 12.

### Second Embodiment

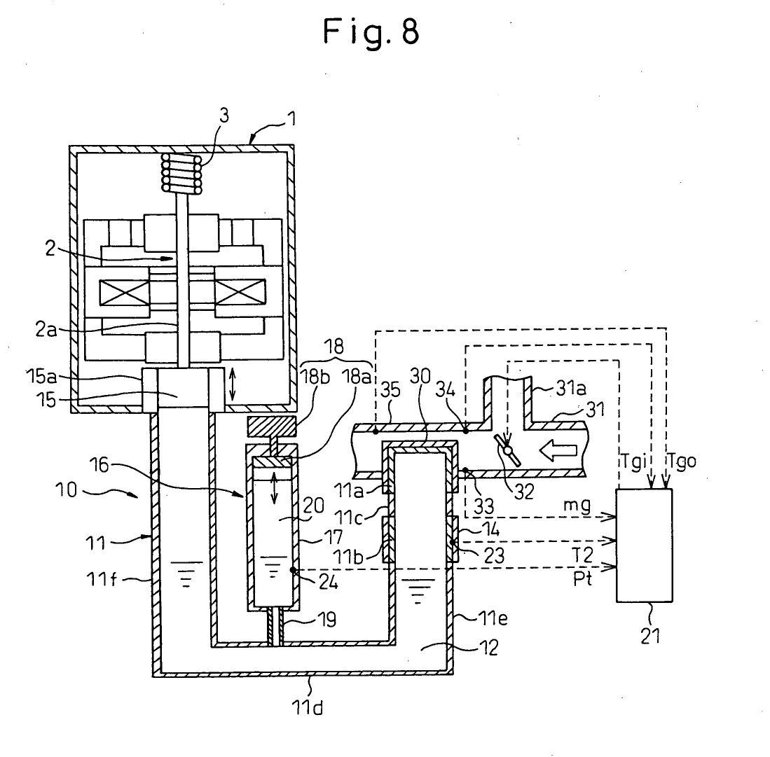

According to the first embodiment described above, the working liquid 12 is heated by the electric heater 13. According to the second embodiment, on the other hand, as shown in FIG. 8, the working liquid 12 is heated by a high-temperature gas (such as the exhaust gas of an automobile).

FIG. 8 is a diagram showing a general configuration of the power generating device according to this embodiment. According to this embodiment, as compared with the first embodiment, the electric heater 13, the temperature controller 13a and the wattage sensor 22 are eliminated. According to this embodiment, on the other hand, a heater 30 for exchanging heat with a high-temperature gas is arranged to cover the heated portion 11a. This heater 30 corresponds to the heating means according to this invention.

The heater 30 is inserted into a gas pipe 31 in which the high-temperature gas flows. A bypass pipe 31a branching from the gas pipe 31 is arranged in the portion of the gas pipe 31 upstream of the heated portion 11a in the high-temperature gas flow.

This branch of the bypass pipe 31a includes a regulating valve 32 for regulating the ratio of flow rate between the high-temperature gas flowing in the heated portion 11a and the high-temperature gas flowing in the bypass pipe 31a. The opening degree of the regulating valve 32 is controlled by the control unit 21.

Also, according to this embodiment, in order to calculate the heated portion temperature T1, the detection signals are input to the control unit 21 from a flow rate sensor 33 for detecting the flow rate (mass flow rate) mg of the high-temperature gas flowing in the heated portion 11a, a pre-heating gas temperature sensor 34 for detecting the high-temperature gas temperature Tgi before heating the heated portion 11a and a post-heating gas temperature sensor 35 for detecting the high-temperature gas temperature Tgo after heating the heated portion 11a.

Incidentally, the flow rate sensor 33 corresponds to the flow rate detecting means according to the invention, the pre-heating gas temperature sensor 34 to the first temperature detecting means according to the invention, and the post-heating gas temperature sensor 35 to the second temperature detecting means according to the invention.

According to this embodiment, the heat quantity Q applied to the working liquid 12 from the heating means (the heater 30 in this embodiment) is calculated from Equation (2) below.

Q=mg·Cgp·(Tgi−Tgo) (2)

where Cgp is the specific heat (kJ/kg·K) of the high-temperature gas. The heated portion temperature T1 is calculated from the heat quantity Q and Equation (1).

As a result, like in the first embodiment, the heated portion temperature T1 can be estimated without detecting the heated portion temperature T1 directly.

### Third Embodiment

According to the first embodiment described above, the deterioration of the performance of the external combustion engine 10, which otherwise might be caused by the change in the saturated vapor pressure Ps1 or the change in the peak value Pc1 of the in-container pressure Pc, is prevented by rendering the peak value Pc1 of the in-container pressure Pc to decrease below the saturated vapor pressure Ps1 and approach the saturated vapor pressure Ps1 as far as possible. According to the third embodiment, on the other hand, the deterioration of the performance of the external combustion engine 10 which otherwise might be caused by the change in the saturated vapor pressure Ps1 or the change in the peak value Pc1 of the in-container pressure Pc is suppressed by rendering the average value Pca of the in-container pressure Pc to approach a target value Pc0.

The average value Pca of the in-container pressure Pc is defined as the one during one period of self vibration of the working liquid 12, and the target value Pc0 as a value approximate to the average value (hereinafter referred to as the ideal average value (FIG. 3A)) Pci of the in-container pressure Pc in the ideal state in which the performance (output and efficiency) of the external combustion engine 10 reaches maximum.

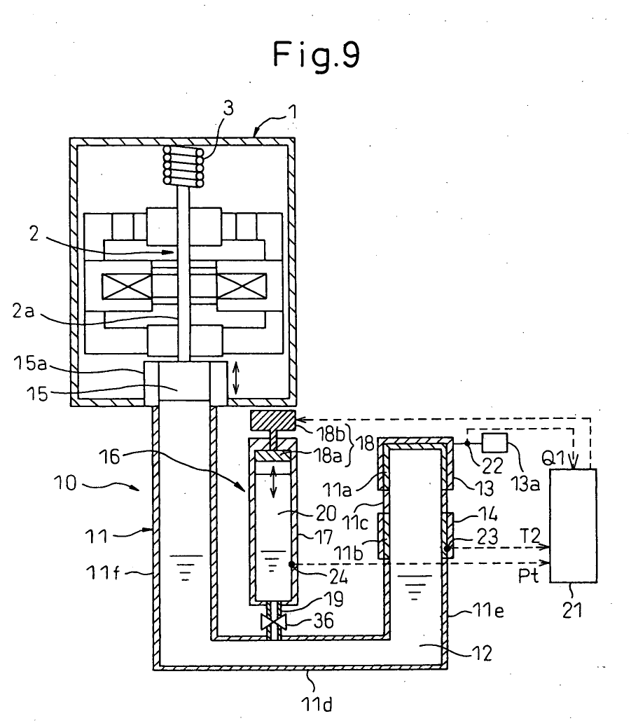

FIG. 9 is a diagram showing a general configuration of a power generating device according to this embodiment. According to this embodiment, as compared with the first embodiment, a restrictor 36 for suppressing the propagation of the in-container pressure Pc into the pressure regulating container 17 is formed in the connecting pipe 19. In this restrictor 36, the path diameter of the connecting pipe 19 is reduced. As a result, the regulating container internal pressure Pt is prevented from changing following the periodic change of the in-container pressure Pc, and therefore, settled at a level substantially equal to the average value Pca of the in-container pressure Pc.

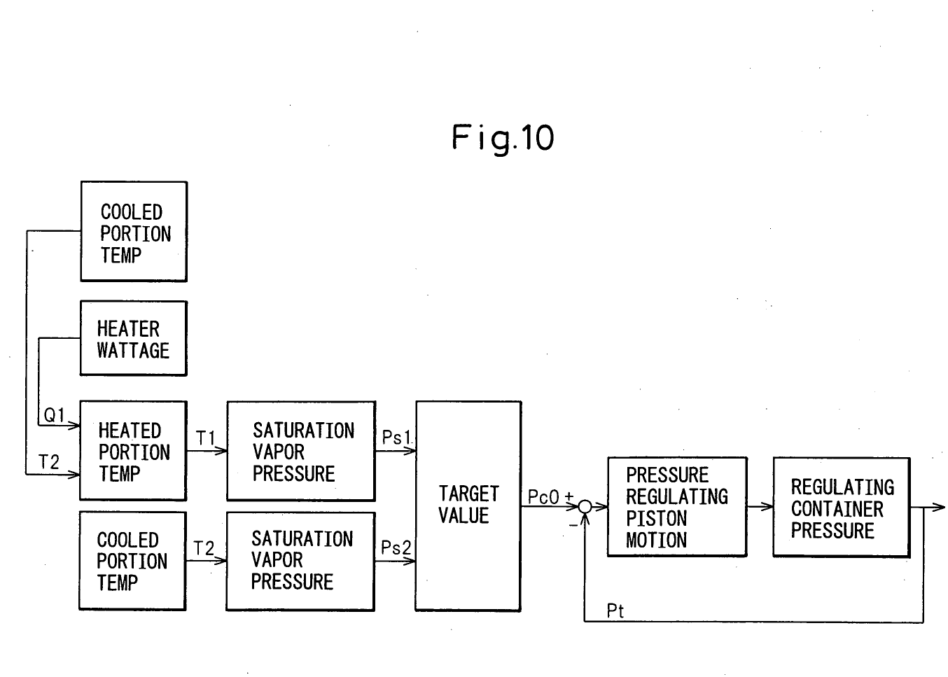

FIG. 10 is a block diagram showing a general operation to control the in-container pressure Pc according to this embodiment. First, like in the first embodiment, the heated portion temperature T1 is calculated by Equation (1) described above. Next, according to this embodiment, the saturated vapor pressure Ps2 of the working liquid 12 at the cooled portion temperature T2 is calculated based on the cooled portion temperature T2 and the vapor pressure curve of the working liquid 12 shown in FIG. 7. Incidentally, the saturated vapor pressure Ps2 of the working liquid 12 at the cooled portion temperature T2 is equal to the minimum value Pc2 (FIGS. 3A to 3C) during one period of the in-container pressure Pc.

Next, the target value Pc0 is calculated based on the saturated vapor pressure Ps1 of the working liquid 12 at the heated portion temperature T1 and the saturated vapor pressure Ps2 of the working liquid 12 at the cooled portion temperature T2. According to this embodiment, the target value Pc0 is set to an intermediate value, or more specifically about an average value, between the saturated vapor pressure Ps1 of the working liquid 12 at the heated portion temperature T1 and the saturated vapor pressure Ps2 of the working liquid 12 at the cooled portion temperature T2.

In the case where the regulating container internal pressure Pt is lower than the target value Pc0, the electrically-operated actuator 18b pushes out the pressure regulating piston 18a and reduces the volume of the pressure regulating container 17. As a result, the pressure regulating liquid 20 is compressed and the regulating container internal pressure Pt rises.

In the case where the regulating container internal pressure Pt is higher than the target value Pc0, on the other hand, the pressure regulating piston 18a is pulled in to reduce the volume of the pressure regulating container 17. As a result, the pressure regulating liquid 20 is expanded and the regulating container internal pressure Pt is reduced.

Then, the average value Pca of the in-container pressure Pc, which also follows the regulating container internal pressure Pt, approaches the target value Pc0. In other words, the average value Pca of the in-container pressure Pc approaches the ideal average value Pci.

As a result, the operating condition of the external combustion engine 10 can always be rendered to approach the ideal state, and therefore, the reduction in the performance (output and efficiency) of the external combustion engine 10 which otherwise might be caused by the change in the saturated vapor pressure Ps1 or the change in the peak value Pc1 of the in-container pressure Pc can be prevented.

According to the first embodiment, the peak value Pt1 of the regulating container internal pressure Pt is detected. In view of the fact that the regulating container internal pressure Pt reaches the peak value Pt1 within a very short time, the sensing period of the regulating container internal pressure sensor 24 for detecting the regulating container internal pressure Pt is greatly shortened.

According to this embodiment, in contrast, as described above, the regulating container internal pressure Pt is settled at a pressure substantially equal to the average value Pca of the in-container pressure Pc without changing following the in-container pressure Pc. As a result, the sensing period of the regulating container internal pressure sensor 24 for detecting the regulating container internal pressure Pt can be set longer than in the first embodiment described above.

Consequently, the detection of the regulating container internal pressure Pt is facilitated as compared with the first embodiment and, therefore, the performance (output and efficiency) of the external combustion engine 10 can be easily improved as compared with the first embodiment.

Incidentally, according to this embodiment, the electric heater 13 is used as a heating means for heating and vaporizing the working liquid 12, and therefore, the heated portion temperature T1 is calculated by Equation (1) described above. As in the second embodiment described above, however, the heated portion temperature T1 may be calculated by Equations (1) and (2) using the heater 30 for exchanging heat with the high-temperature gas as a heating means.

### Fourth Embodiment

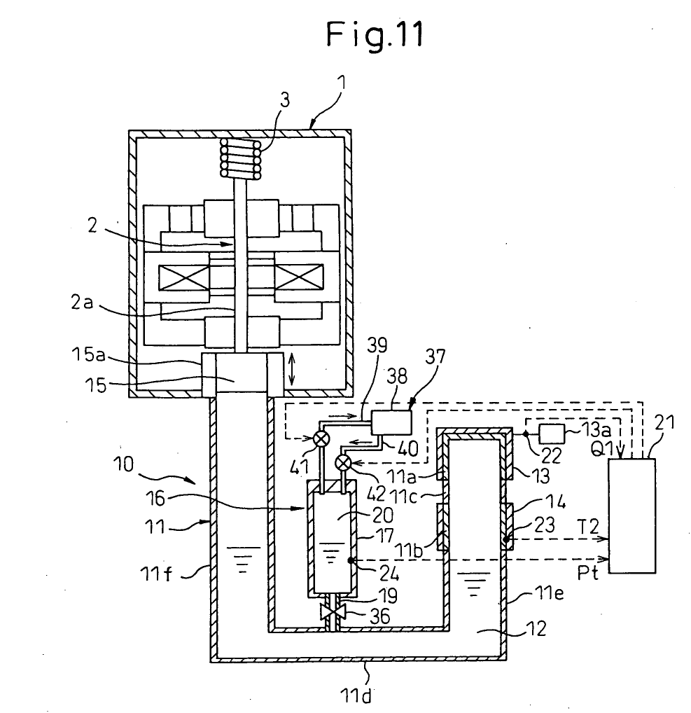

In the third embodiment described above, the pressure regulating means 16 is comprised of the pressure regulating container 17 and the piston mechanism 18. In the fourth embodiment, on the other hand, as shown in FIG. 11, the pressure regulating means 16 is comprised of a pressure regulating container 17 and a pump mechanism 37.

FIG. 11 is a diagram showing a general configuration of a power generating device according to this embodiment. The pump mechanism 37 includes a pump 38, an intake pipe 39, a discharge pipe 40, an intake on/off valve 41 and a discharge on/off valve 42.

The pump 38 for sucking in and storing therein the pressure regulating liquid 20 in the pressure regulating container 17 and discharging the stored pressure regulating liquid 20 to the pressure regulating container 17 is connected to the pressure regulating container 17 through the intake pipe 39 and the discharge pipe 40.

The intake on/off valve 41 is arranged in the intake pipe 39, and once the intake on/off valve 41 is opened, the pressure regulating liquid 20 in the pressure regulating container 17 is sucked in by the pump 38 and stored therein.

The discharge on/off valve 42 is arranged in the discharge pipe 40, and once the discharge on/off valve 42 is opened, the pressure regulating liquid 20 stored in the pump 38 is discharged to the pressure regulating container 17. The operation of the on/off valves 41, 42 is controlled by the control unit 21.

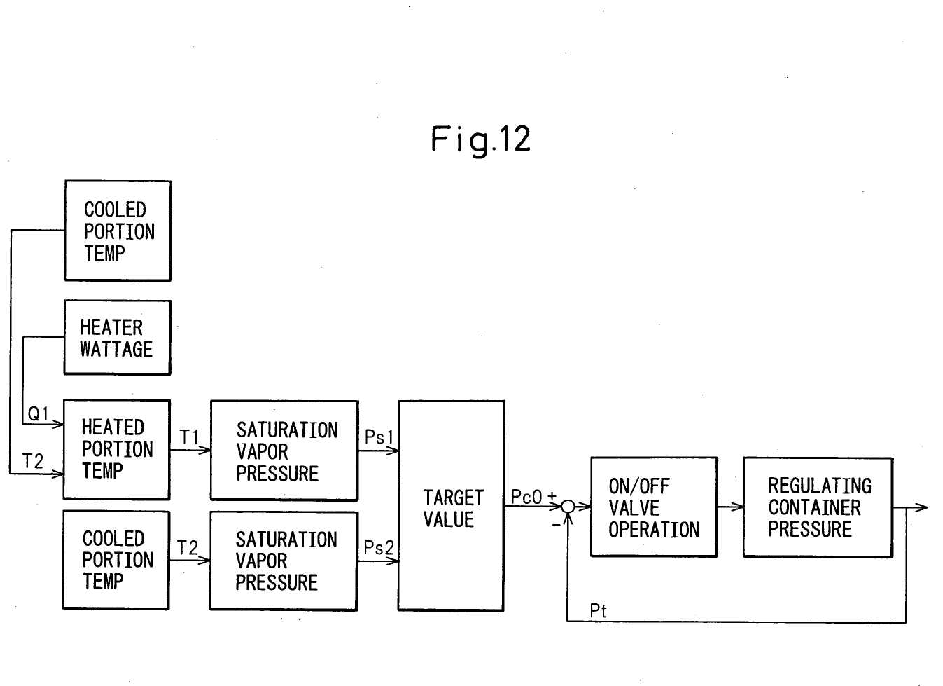

FIG. 12 is a block diagram showing a general operation to control the in-container pressure Pc according to this embodiment. According to this embodiment, in the case where the regulating container internal pressure Pt is lower than the target value Pc0, the intake on/off valve 41 is closed and the discharge on/off valve 42 is opened thereby to increase the volume of the working liquid 12. As a result, the regulating container internal pressure Pt increases.

In the case where the regulating container internal pressure Pt is higher than the target value Pc0, on the other hand, the intake on/off valve 41 is opened while the discharge on/off valve 42 is closed thereby to reduce the volume of the pressure regulating liquid 20 in the pressure regulating container 17. As a result, the regulating container internal pressure Pt is decreased.

Then, like in the second embodiment, the average value Pca of the in-container pressure Pc approaches the target value Pc0. As a result, the operating condition of the external combustion engine 10 can always be rendered to approach the ideal state. Thus, the reduction of the performance (output and efficiency) of the external combustion engine 10 which otherwise might be caused by the change in the saturated vapor pressure Ps1 or the peak value Pc1 of the in-container pressure Pc can be prevented.

According to this embodiment, and as in the second embodiment, the reduction of the performance (output and efficiency) of the external combustion engine 10 which otherwise might be caused by the change in the saturated vapor pressure Ps1 or the peak value Pc1 of the in-container pressure Pc is prevented by rendering the average value Pca of the in-container pressure Pc to approach the target value Pc0. As in the first embodiment, however, the restrictor 36 may be eliminated, and the reduction in the performance (output and efficiency) of the external combustion engine 10, which otherwise might be caused by the change in the saturated vapor pressure Ps1 or the peak value Pc1 of the in-container pressure Pc, may be prevented by setting the peak value Pc1 of the in-container pressure Pc to a level lower than the saturated vapor pressure Ps1 and rendered to approach the saturated vapor pressure Ps1 as far as possible.

According to this embodiment, the electric heater 13 is used as a heating means for heating and vaporizing the working liquid 12 and, therefore, the heated portion temperature T1 is calculated using Equation (1). As in the second embodiment, however, the heater 30 for exchanging heat with the high-temperature gas may be used as a heating means, and the heated portion temperature T1 may be calculated according to Equations (1) and (2) described above.

### Fifth Embodiment

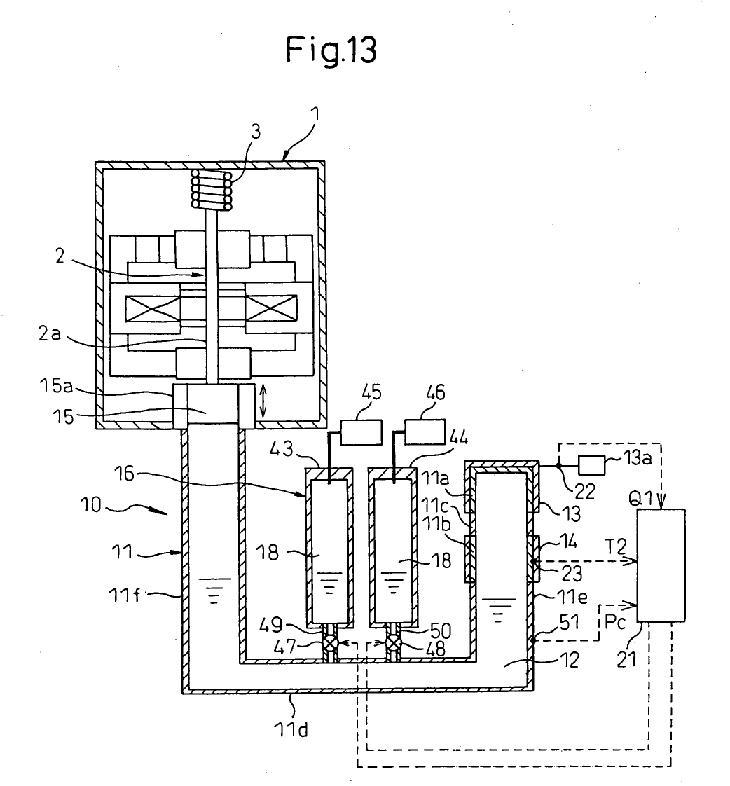

In the fourth embodiment described above, the in-container pressure Pc is regulated using one pressure regulating container 17. In the fifth embodiment, in contrast, as shown in FIG. 13, the in-container pressure Pc is controlled using two regulating containers 43, 44.

FIG. 13 is a diagram showing a general configuration of a power generating device according to this embodiment. According to this embodiment, the pressure regulating means 16 is comprised of two regulating containers 43, 44, two pumps 45, 46 and two on/off valves 47, 48.

The two regulating containers 43, 44 communicate with a bent portion lid through the connecting pipes 49, 50, respectively. The two regulating containers 43, 44 are kept at different levels of pressure by the pumps 45, 46, respectively. The two on/off valves 47, 48 are arranged in the two connecting pipes 49, 50, respectively, and the on/off operation of the two on/off valves 47, 48 is controlled independently of each other by the control unit 21.

Also, according to this embodiment, the regulating container internal pressure sensor 24 for detecting the regulating container internal pressure Pt is eliminated, and, in its place, the detection signal from the in-container pressure sensor 51 for detecting the in-container pressure Pc is input to the control unit 21.

The internal pressure of the regulating container 43 is always kept at a level higher than the target value Pc0 by the pump 45, while the internal pressure of the other regulating container 44 maintained at a level lower than the target value Pc0 by the pump 46.

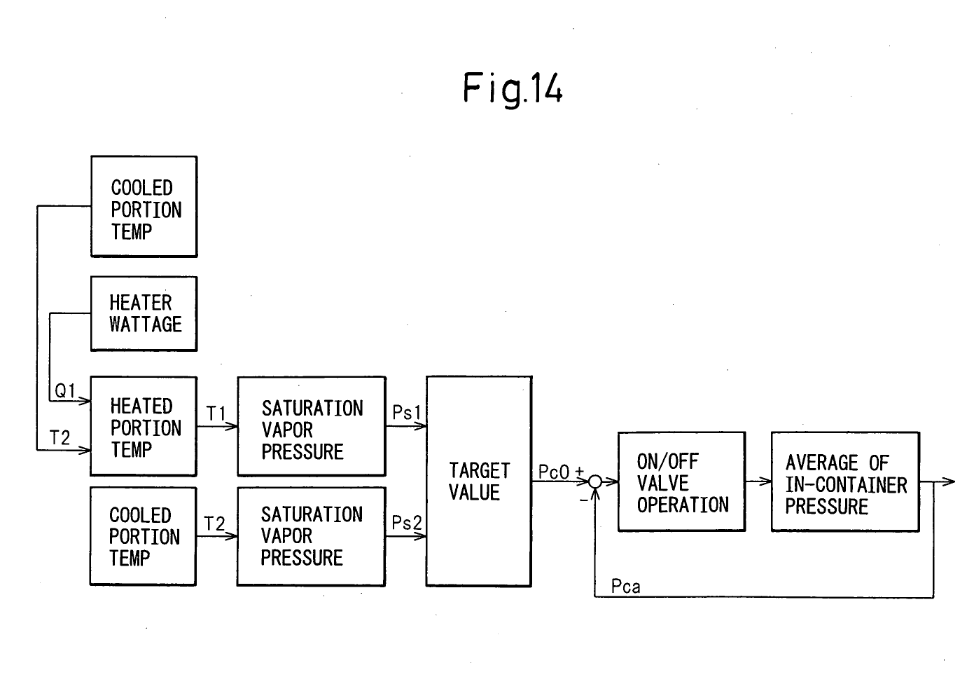

FIG. 14 is a block diagram showing a general operation to control the in-container pressure Pc according to this embodiment. In this embodiment, as long as the average value Pca of the in-container pressure Pc is lower than the target value Pc0, the on/off valve 47 of the regulating container 43 is opened, while the on/off valve 48 of the other regulating container 44 is closed. As a result, the in-container pressure Pc increases.

In the case where the average value Pca of the in-container pressure Pc is higher than the target value Pc0, on the other hand, the on/off valve 47 of the regulating container 43 is closed while opening the on/off valve 48 of the other regulating container 44. As a result, the in-container pressure Pc is decreased.

Then, like in the third embodiment, the average value Pca of the in-container pressure Pc approaches the target value Pc0. As a result, the operating condition of the external combustion engine 10 can always be rendered to approach the ideal state and, therefore, the reduction in the performance (output and efficiency) of the external combustion engine 10, which otherwise might be caused by the change in the saturated vapor pressure Ps1 or the change in the peak value Pc1 of the in-container pressure Pc, can be prevented.

Although this embodiment uses the two pumps 45, 46 to apply pressure into the two regulating containers 43, 44 differently from each other, the interior of the two regulating containers 43, 44 may alternatively be kept at different pressure levels by use of a common pump.

Also, instead of using the two regulating containers 43, 44 set to different pressures as in this embodiment, three or more regulating containers may be used to set different pressures.

In this case, three or more regulating containers are each equipped with an on/off valve, and in the case where the average value Pca of the in-container pressure Pc is lower than the target value Pc0, the on/off valve of only one of the three regulating containers of which the regulating container internal pressure is lower than and nearest to the target value Pc0 is opened, while in the case where the average value Pca of the in-container pressure Pc is lower than the target value Pc0, on the other hand, the on/off valve of only one of the three regulating-containers, of which the regulating container internal pressure is higher than and nearest to the target value Pc0, is opened.

According to this embodiment, the electric heater 13 is used as a heating means for heating and vaporizing the working liquid 12, and therefore, the heated portion temperature T1 is calculated using Equation (1). As in the second embodiment, however, the heated portion temperature T1 may be calculated according to Equations (1), (2) using the heater 30 for exchanging heat with the high-temperature gas as a heating means.

### Sixth Embodiment

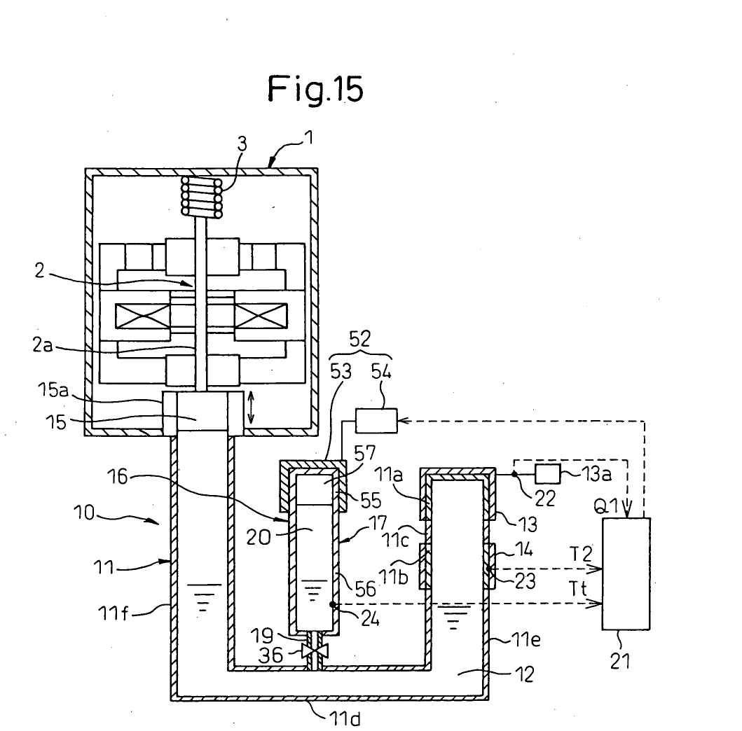

According to the third embodiment described above, the pressure regulating means 16 includes the pressure regulating container 17 and the piston mechanism 18, while in the fourth embodiment, the pressure regulating means 16 is comprised of the pressure regulating container 17 and the pump mechanism 37. According to the sixth embodiment, on the other hand, as shown in FIG. 15, the pressure regulating means 16 is comprised of the pressure regulating container 17 and the pressure-regulating heating device 52.

FIG. 15 is a diagram showing a general configuration of a power generating device according to this embodiment. The pressure-regulating heating device 52 is comprised of a pressure-regulating electric heater 53 closely arranged at a portion of the pressure regulating container 17 far from the connecting pipe 19 (upper end in FIG. 15) and a pressure-regulating temperature controller 54 for regulating the temperature of the pressure-regulating electric heater 53.

The control unit 21 controls the pressure-regulating temperature controller 54 thereby to regulate the heat quantity supplied from the pressure-regulating electric heater 53 to the pressure regulating container 17.

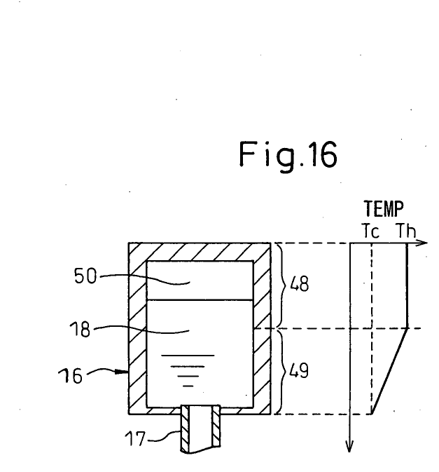

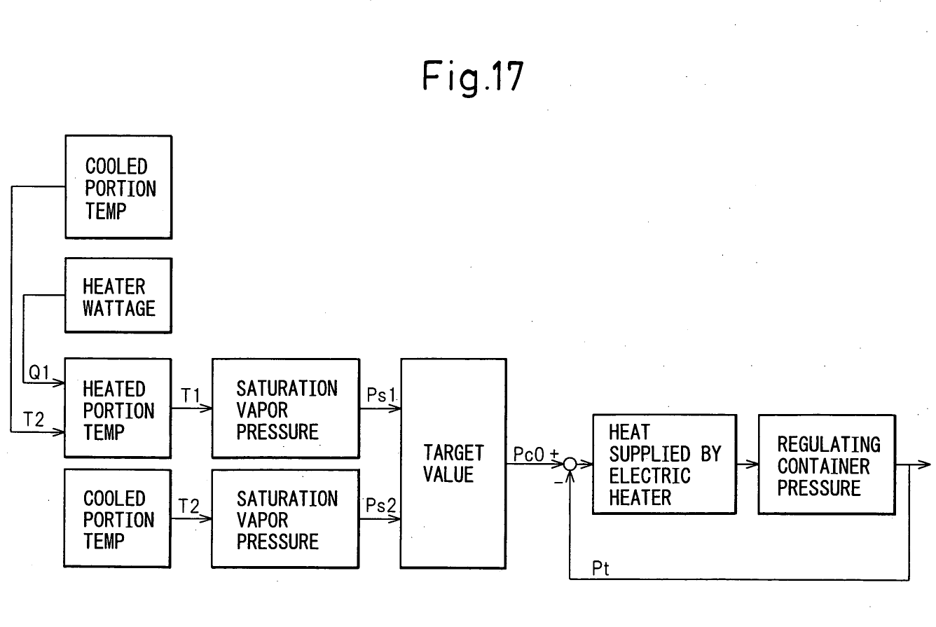

FIG. 16 is a graph showing the temperature gradient of the pressure regulating container 17 heated by the pressure-regulating electric heater 53. As shown in FIG. 16, the pressure regulating container 17 has such a heat conducting structure that the temperature gradient of the high-temperature portion 55 far from the connecting pipe 19 is negligibly small, while the temperature of the low-temperature portion 56 near to the connecting pipe 19 decreases progressively with the increase in the distance from the high-temperature portion 55. In FIG. 16, the temperature Th is that of the high-temperature portion 55 (hereinafter referred to as the high-temperature portion temperature).

Also, the temperature Tc is that of the end portion of the low-temperature portion 56 near to the connecting pipe 19 (hereinafter referred to as the low-temperature portion temperature) and substantially equal to the cooled portion temperature T2 (accurately, slightly higher than the cooled portion temperature T2). The cooled portion temperature T2, therefore, is not higher than the boiling point of the pressure regulating liquid 20.

The pressure regulating liquid 20 in the high-temperature portion 55 is heated and vaporized by the pressure-regulating electric heater 53, and the high-temperature high-pressure vapor 57 is accumulated in the high-temperature portion 55 thereby to push down the liquid level of the pressure regulating liquid 20 in the high-temperature portion 55.

The temperature of the low-temperature portion 56, on the other hand, decreases progressively with the increase in the distance from the high-temperature portion 55, and therefore, the liquid level of the pressure regulating liquid 20 is kept located in the high-temperature portion 55 without being pushed down to the low-temperature portion 56. As a result, the pressure regulating liquid 20 is kept in contact with the high-temperature portion 55 and, therefore, the pressure regulating container 17 is kept in boiling state. Thus, the regulating container internal pressure Pt can be kept at the same level as the saturated vapor pressure of the pressure regulating liquid 20 at the high-temperature portion temperature Th of the pressure regulating container 17.

FIG. 13 is a block diagram showing a general operation to control the in-container pressure Pc according to this embodiment. According to this embodiment, in the case where the regulating container internal pressure Pt is lower than the target value Pc0, the pressure-regulating temperature controller 54 increases the temperature of the pressure-regulating electric heater 53 and hence the high-temperature portion temperature Th of the pressure regulating container 17. As a result, the saturated vapor pressure of the pressure regulating liquid 20 increases and so does the regulating container internal pressure Pt.

In the case where the regulating container internal pressure Pt is higher than the target value Pc0, on the other hand, the pressure-regulating temperature controller 54 decreases the temperature of the pressure-regulating electric heater 53 thereby to reduce the high-temperature portion temperature Th of the pressure regulating container 17. As a result, the saturated vapor pressure of the pressure regulating liquid 20 is decreased and so is the regulating container internal pressure Pt.

Then, as in the second and third embodiments, the average value Pca of the in-container pressure Pc approaches the target value Pc0. As a result, the operating condition of the external combustion engine 10 can always be rendered to approach the ideal state, and therefore, the deterioration of the performance (output and efficiency) of the external combustion engine 10 which otherwise might be caused by the change in the saturated vapor pressure Ps1 or the change in the peak value Pc1 of the in-container pressure Pc can be prevented.

The vapor 57 in the high-temperature portion 55 may be either the pure vapor of the pressure regulating liquid 20 or a mixture of the vapor of the pressure regulating liquid 20 and another gas (such as air).

According to this embodiment, the electric heater 13 is used as the heating means for heating and vaporizing the working liquid 12, and therefore, the heated portion temperature T1 is calculated according to Equation (1). Like in the second embodiment, however, the heated portion temperature T1 may alternatively be calculated by Equations (1) and (2) using the heater 30 for exchanging heat with the high-temperature gas as a heating means.

Also, according to this embodiment, the pressure regulating liquid 20 in the pressure regulating container 17 is vaporized by the pressure-regulating electric heater 53. Nevertheless, the pressure regulating liquid 20 in the pressure regulating container 17 may alternatively be vaporized using a high-temperature gas as a heat source.

### Seventh Embodiment

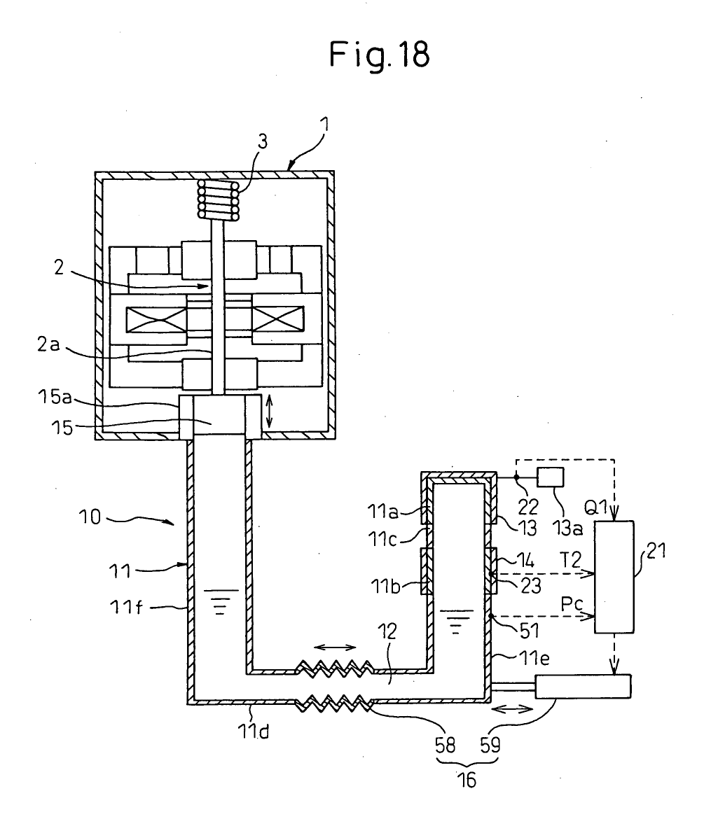

According to the third, fourth and sixth embodiments described above, the in-container pressure Pc is regulated by arranging the pressure regulating container 17 and regulating the regulating container internal pressure Pt. According to the seventh embodiment, however, as shown in FIG. 18, the pressure regulating container 17 is eliminated, and the in-container pressure Pc is regulated by regulating the volume of the container 11.

FIG. 18 is a diagram showing a general configuration of a power generating device according to this embodiment. According to this embodiment, the pressure-regulating means 16 is comprised of an expansion and contraction portion 58 of the container 11 and an electrically-operated actuator 59. The expansion and contraction portion 58 is formed as a bellows on the bent portion lid of the container 11 in a way adapted to extend and contract in horizontal direction. The electrically-operated actuator 59 for expanding and contracting the expansion and contraction portion 58 is coupled to the container 11.

The electrically-operated actuator 59 is controlled by the control unit 21 based on the heated portion temperature T1 calculated according to Equation (1), the cooled portion temperature T2 detected by the cooled portion temperature sensor 23 and the in-container pressure Pc detected by the in-container pressure sensor 51.

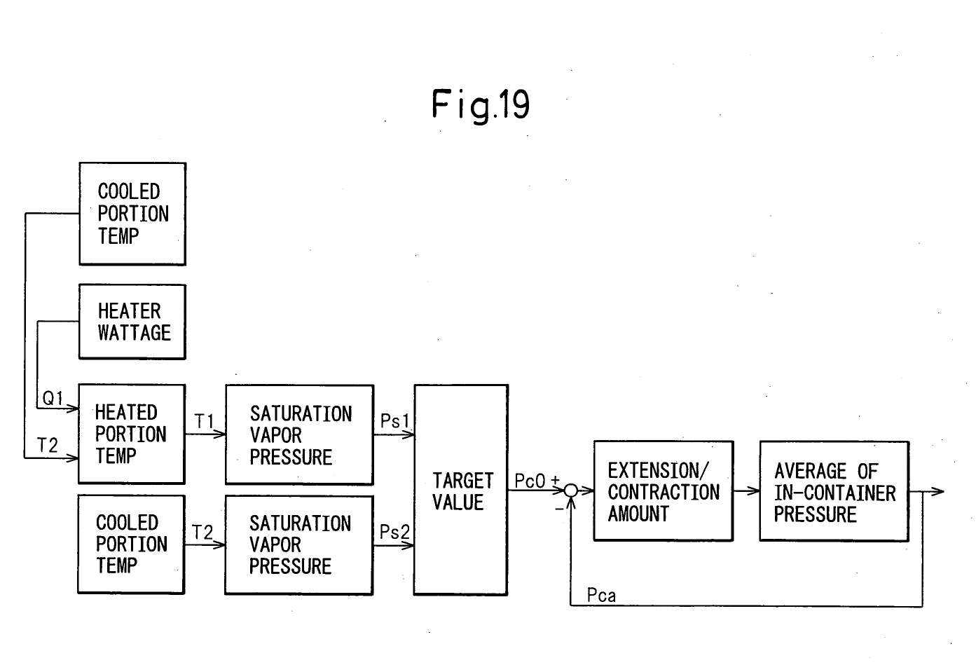

FIG. 19 is a block diagram showing a general operation to control the in-container pressure Pc according to this embodiment. First, as in the third embodiment, the heated portion temperature T1 is calculated according to Equation (1) described above, after which the target value Pc0 is calculated based on the saturated vapor pressure Ps1 of the working liquid 12 at the heated portion temperature T1 and the saturated vapor pressure Ps2 of the working liquid 12 at the cooled portion temperature T2.

According to this embodiment, in the case where the average value Pca of the in-container pressure Pc is lower than the target value Pc0, the in-container pressure Pc is increased by controlling the electrically-operated actuator 59 in such a manner as to contract the expansion and contraction portion 58.

In the case where the average value Pca of the in-container pressure Pc is higher than the target value Pc0, on the other hand, the in-container pressure Pc is decreased by controlling the electrically-operated actuator 59 in such a manner as to expand the expansion and contraction portion 58.

As a result, the average value Pca of the in-container pressure Pc approaches the target value Pc0. Thus, the operating condition of the external combustion engine 10 can always be rendered to approach the ideal state, and therefore, the deterioration of the performance (output and efficiency), which otherwise might be caused by the change in the saturated vapor pressure Ps1 or the change in the peak value Pc1 of the in-container pressure Pc, can be prevented.

Incidentally, according to this embodiment, the average value Pca of the in-container pressure Pc is rendered to approach the target value Pc0. As an alternative, however, the peak value Pc1 of the in-container pressure Pc may be rendered to approach the saturated vapor pressure Ps1.

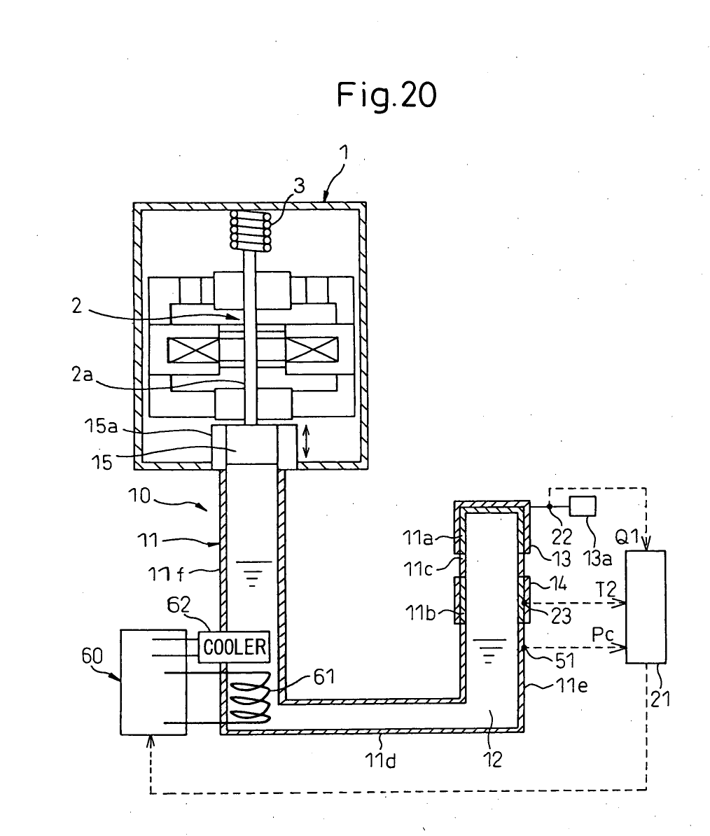

Also, according to this embodiment, the electric heater 13 is used as a heating means for heating and vaporizing the working liquid 12, and the heated portion temperature T1 is calculated according to Equation (1). As an alternative, as in the second embodiment, the heated portion temperature T1 may be calculated by Equations (1), (2) using the heater 30 for exchanging heat with the high-temperature gas as a heating means. (Eighth embodiment) In the seventh embodiment described above, the in-container pressure Pc is regulated by regulating the volume of the container 11. According to the eighth embodiment, in contrast, as shown in FIG. 20, the in-container pressure Pc is regulated by controlling the temperature of the working liquid 12.

FIG. 20 is a diagram showing a general configuration of the power generating device according to this embodiment. The pressure regulating means 60 according to this embodiment is comprised of a temperature controller for maintaining the temperature of the working liquid 12 at a constant level.

This temperature controller 60 is arranged at a portion of the container 11 other than the heated portion 11a and the cooled portion 11b, and includes a heater unit 61 for heating the working liquid 12 and a cooler unit 62 for cooing the working liquid 12.

The on/off control operation of the heater unit 61 and the cooler unit 62 of the temperature controller 60 is performed by the control unit 21 based on the heated portion temperature T1 calculated by Equation (1) and the in-container pressure Pc detected by the in-container pressure sensor 51.

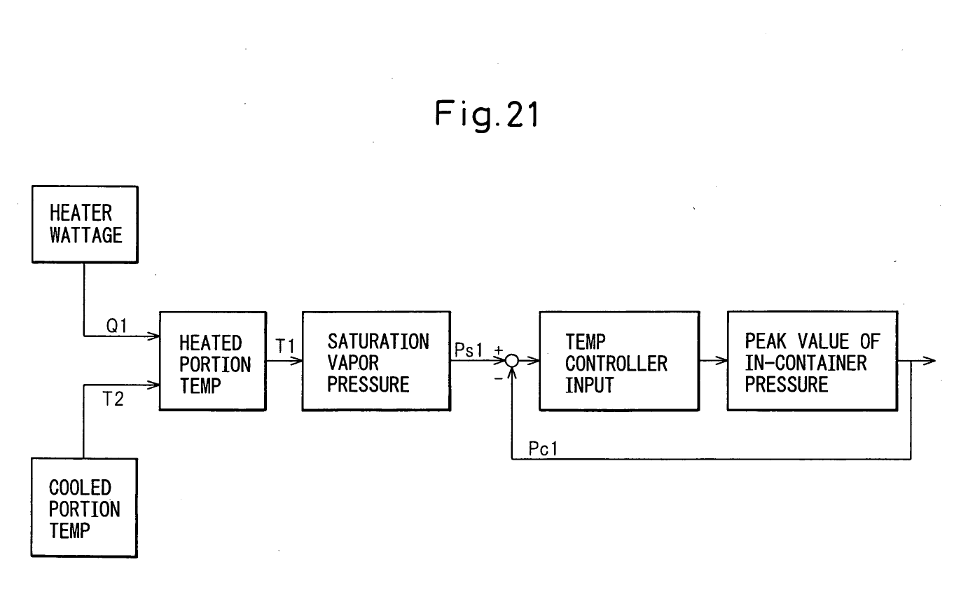

FIG. 21 is a block diagram showing a general operation to control the in-container pressure Pc according to this embodiment. According to this embodiment, the saturated vapor pressure Ps1 of the working liquid 12 at the heated portion temperature T1 is calculated based on the heated portion temperature T1 calculated by Equation (1) and the vapor pressure curve of the working liquid 12 shown in FIG. 7.

In the case where the peak value Pc1 of the in-container pressure Pc is higher than the saturated vapor pressure Ps1, the cooler unit 62 is activated and cools the working liquid 12. As a result, the working liquid 12 is thermally contracted, and therefore, the in-container pressure Pc decreases, thereby decreasing the peak value Pc1 of the in-container pressure Pc.

In the case where the peak value Pc1 of the in-container pressure Pc is lower than the saturated vapor pressure Ps1, on the other hand, the heater unit 61 is activated and heats the working liquid 12. As a result, the working liquid 12 is thermally expanded, and the in-container pressure Pc increases, thereby increasing the peak value Pc1 of the in-container pressure Pc.

In this way, the peak value Pc1 of the in-container pressure Pc approaches the saturated vapor pressure Ps1 of the working liquid 12 at the heated portion temperature T1. As a result, the operating condition of the external combustion engine 10 can always be rendered to approach the ideal state. Thus, the deterioration of the performance (output and efficiency) which otherwise might be caused by the change in the saturated vapor pressure Ps1 and the change in the peak value Pc1 of the in-container pressure Pc can be prevented.

According to this embodiment, the electric heater 13 is used as a heating means for heating and vaporizing the working liquid 12 and the heated portion temperature T1 is calculated by Equation (1). Like in the second embodiment, however, the heated portion temperature T1 may be calculated by Equations (1) and (2) using the heater 30 for exchanging heat with the high-temperature gas as a heating means.

### Ninth Embodiment

In the first, second and eighth embodiments described above, the deterioration of the performance (output and efficiency) of the external combustion engine 10 which otherwise might be caused by the change in the saturated vapor pressure Ps1 and the change in the peak value Pc1 of the in-container pressure Pc can be prevented by reducing the peak value Pc1 of the in-container pressure Pc below the saturated vapor pressure Ps1 and rendering the peak value Pc1 to approach the saturated vapor pressure Ps1 as far as possible. Also, in the third, fourth, fifth, sixth and seventh embodiments described above, the deterioration of the performance (output and efficiency) of the external combustion engine 10 which otherwise might be caused by the change in the saturated vapor pressure Ps1 and the change in the peak value Pc1 of the in-container pressure Pc can be prevented by rendering the average value Pca of the in-container pressure Pc to approach the target value Pc0.

According to the ninth embodiment, in contrast, the deterioration of the performance (output and efficiency) of the external combustion engine 10 which otherwise might be caused by the change in the peak value Pc1 of the in-container pressure Pc can be prevented by discharging the working liquid 12 outside in an amount by which the in-container pressure Pc exceeds the saturated vapor pressure Ps1.

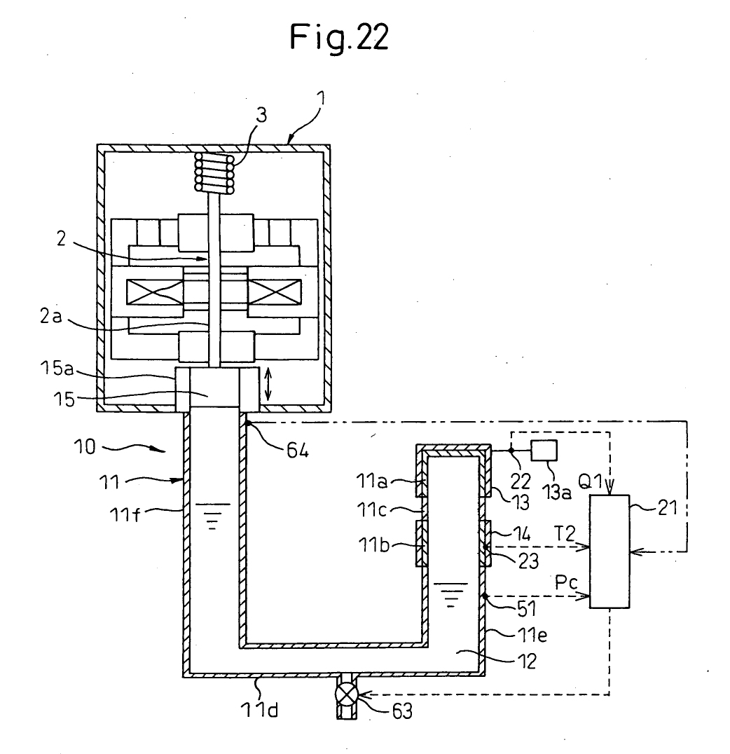

FIG. 22 is a diagram showing a general configuration of the power generating device according to this embodiment. This embodiment represents an application of the invention to the conventional technique described above (Japanese Unexamined Patent Publication No. 2005-330910). Specifically, in the prior art described above, the heated portion temperature T1 is detected directly, while according to this embodiment, the heated portion temperature T1 is calculated based on the wattage Q1 input to the electric heater 13. The other parts of the configuration are similar to those of the prior art described above.

The pressure regulating means 63 according to this embodiment is comprised of a valve 63 for establishing communication between the interior of the container 11 and the atmosphere.

The on/off control operation of the valve 63 is performed by the control unit 21 based on the heated portion temperature T1 calculated by Equation (1) and the in-container pressure Pc detected by the in-container pressure sensor 51.

Specifically, the saturated vapor pressure Ps1 of the working liquid 12 at the heated portion temperature T1 is calculated based on the heated portion temperature T1 calculated by Equation (1) and the vapor pressure curve of the working liquid 12 shown in FIG. 7.

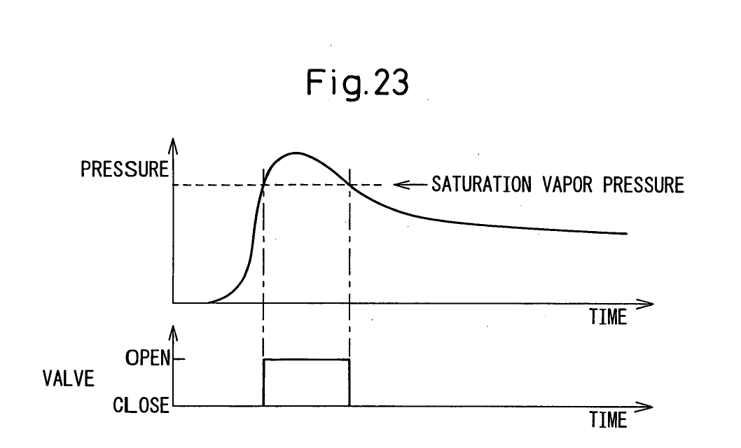

Next, in the case where the in-container pressure Pc is not lower than the saturated vapor pressure Ps1, as shown in FIG. 23, the valve 63 is opened and the working liquid 12 in the container 11 is discharged into the atmosphere, while in the case where the in-container pressure Pc is lower than the saturated vapor pressure Ps1, on the other hand, the valve 63 is closed.

As a result, the internal pressure of the container 11 is prevented from exceeding the saturated vapor pressure of the working liquid 12 during the operation of the external combustion engine 10.

Incidentally, during the operation of the external combustion engine 10, the internal pressure of the container 11 reaches a maximum when the piston 15 is located at the top dead center (lowest position in FIG. 22) where the piston volume is smallest. As indicated by two-dot chain in FIG. 22, therefore, a position sensor 64 for detecting the position of the piston 15 is arranged, and the timing at which the piston 15 is located at the bottom dead center is detected through the position sensor 64, and in synchronism with the particular detection timing, the on/off control operation of the valve 63 may be performed.

In this case, the on/off control operation of the valve 63 is performed in such a manner that once the internal pressure of the container 11 retrieved from the pressure sensor 36 with the piston 15 at the bottom dead center increases to or higher than the saturated vapor pressure, the valve 63 is opened for a predetermined period of time shorter than the reciprocation period of the piston 15. In this way, the working liquid in the container 11 is discharged stepwise.

According to this embodiment, the electric heater 13 is used as a heating means for heating and vaporizing the working liquid 12, and therefore, the heated portion temperature T1 is calculated by Equation (1). As in the second embodiment, however, the heated portion temperature T1 may be calculated by Equations (1) and (2) using the heater 30 for exchanging heat with the high-temperature gas as a heating means.

### Other Embodiments

According to each embodiment described above, the heated portion temperature T1 is calculated by Equation (1). As an alternative, the heated portion temperature T1 may be calculated by correcting Equation (1) using an appropriate coefficient.

Also, although the heat quantity Q applied from the high-temperature gas to the electric heater 13 is calculated by Equation (2), the heated portion temperature T1 may be calculated by correcting Equation (2) using an appropriate coefficient.

Further, although this embodiment represents an application of the invention to a drive source of the power generating device. Nevertheless, the external combustion engine according to this invention can be used also as a drive source other than the power generating device.

While the invention has been described by reference to specific embodiments chosen for purposes of illustration, it should be apparent that numerous modifications could be made thereto, by those skilled in the art, without departing from the basic concept and scope of the invention.

1. An external combustion engine for outputting mechanical energy by converting the displacement of a working liquid caused by the volume change of the vapor of the working liquid into mechanical energy, comprising:
a container sealed with a working liquid in a way adapted to allow the liquid to flow therein;
a heating means for heating and vaporizing the working liquid in the container;
a cooling means for cooling and liquefying the vapor of the working liquid heated and vaporized by the heating means;
a pressure regulating means for regulating the internal pressure (Pc) of the container; and
a control means for controlling the pressure regulating means based on at least the temperature (T1) of the heated portion of the container for vaporizing the working liquid;
wherein the control means calculates the temperature (T1) based on at least the heat quantity (Q) applied to the working liquid from the heating means.

2. The external combustion engine according to claim 1,
wherein the control means calculates the saturated vapor pressure (Ps1) of the working liquid at the temperature (T1) based on the temperature (T1) and the vapor pressure curve of the working liquid.

3. The external combustion engine according to claim 2,
wherein the control means controls the pressure regulating means in such a manner that the internal pressure (Pc), if not lower than the saturated vapor pressure (Ps1), is decreased.

4. The external combustion engine according to claim 2,
wherein the control means controls the pressure regulating means in such a manner that the internal pressure (Pc), if not lower than the saturated vapor pressure (Ps1), is decreased and, if not higher than the saturated vapor pressure (Ps1), is increased.

5. The external combustion engine according to claim 2,
wherein the control means controls the pressure regulating means in such a manner that the internal pressure (Pc) is decreased in the case where the average value (Pca) of the internal pressure (Pc) is not lower than the target value (Pc0) calculated based on at least the saturated vapor pressure (Ps1) and the internal pressure (Pc) is increased in the case where the average value (Pca) is not higher than the target value (Pc0).

6. A temperature calculating device used with an external combustion engine for outputting mechanical energy by converting the displacement of a working liquid caused by the vapor volume change of the working liquid into mechanical energy, comprising a container sealed with the working liquid adapted to allow the liquid to flow therein, a heating means for heating and vaporizing the working liquid in the container and a cooling means for cooling and liquefying the vapor of the working liquid heated and vaporized by the heating means,
wherein the temperature (T1) of the heated portion of the container for vaporizing the working liquid is calculated based on at least the heat quantity (Q) applied to the working liquid from the heating means.

7. The temperature calculating device for the external combustion engine according to claim 6,
wherein the control means calculates the temperature (T1) using Equation (1) below:
T1=Q/(m·Cp)−T0 (1)
where m is the mass of the heated portion, Cp the specific heat of the heated portion, and T0 the temperature of the heated portion before being heated by the heating means.

8. The temperature calculating device for the external combustion engine according to claim 6,
wherein the heating means is an electric heater, the temperature calculating device further comprising a wattage detecting means for detecting the wattage (Q1) input to the electric heater, and
wherein the control means calculates the temperature (T1) using the wattage (Q1) in place of the heat quantity (Q).

9. The temperature calculating device for the external combustion engine according to claim 6;
wherein the heating means is a heater for exchanging heat with a high-temperature gas, the temperature calculating device comprising,
a first temperature detecting means for detecting the temperature (Tgi) of the high-temperature gas before exchanging heat with the heated portion,
a second temperature detecting means for detecting the temperature (Tgo) of the high-temperature gas after exchanging heat with the heated portion, and
a flow rate detecting means for detecting the flow rate (mg) of the high-temperature gas;
wherein the control means calculates the heat quantity (Q) based on at least the temperature (Tgi) of the high-temperature gas before exchanging heat with the heated portion, the temperature (Tgo) of the high-temperature gas after exchanging heat with the heated portion and the flow rate (mg).

10. The temperature calculating device for the external combustion engine according to claim 9,
wherein the control means calculates the heat quantity (Q) using Equation (2) below:
Q=mg·Cgp·(Tgi−Tgo) (2)
where Cgp is the specific heat of the high-temperature gas.
